(19) United States
(12) Patent Application Publication
(10) Pub. No.: US 2023/0421064 A1
(43) Pub. Date: Dec. 28, 2023

(54) POWER CONTROL DEVICE, AC/DC CONVERTER, AND AC ADAPTER

(71) Applicant: Rohm Co., Ltd., Kyoto (JP)

(72) Inventor: Satoru NATE, Kyoto (JP)

(21) Appl. No.: 18/323,960

(22) Filed: May 25, 2023

(30) Foreign Application Priority Data
Jun. 22, 2022 (JP) 2022-100068

(51) Int. Cl. H02M 3/335; H02M 1/08

(52) U.S. Cl. CPC H02M 3/33507; H02M 1/08

(57) ABSTRACT

A power control device is configured to control a DC/DC converter in an AC/DC converter, and includes a rectification circuit configured to be fed with an alternating-current voltage, an input capacitor configured to smooth the voltage rectified by the rectification circuit, and the DC/DC converter configured to perform DC/DC conversion on the input voltage appearing across the input capacitor. The DC/DC converter includes a switching element, and the power control device includes a switching frequency controller configured to increase the switching frequency at which the switching element is switched as the input voltage is lower.

### BACKGROUND OF THE INVENTION

This application is based on and claims the benefit of priority from Japanese Patent Application No. 2022-100068 filed on Jun. 22, 2022, the contents of which are hereby incorporated by reference.

### FIELD OF THE INVENTION

The present disclosure relates to a power control device.

### DESCRIPTION OF THE RELATED ART

For example, some conventional AC/DC converters for converting an alternating-current voltage to a direct-current voltage are known to include a transformer and a switching element connected to the primary winding of the transformer. This switching element is driven and controlled by a control IC (integrated circuit) (see, for example, JP-A-2015-133907).

AC/DC converters as mentioned above are expected to produce as little loss in the switching element and generate as little heat as possible.

Under these circumstances, the present disclosure aims at providing a power control device that can suppress loss in a switching element.

### SUMMARY OF THE INVENTION

For example, according to one aspect of the present disclosure, a power control device is configured to control a DC/DC converter in an AC/DC converter, and includes a rectification circuit configured to be fed with an alternating-current voltage, an input capacitor configured to smooth the voltage rectified by the rectification circuit, and the DC/DC converter configured to perform DC/DC conversion on the input voltage appearing across the input capacitor. The DC/DC converter includes a switching element, and the power control device includes a switching frequency controller configured to increase the switching frequency at which the switching element is switched as the input voltage is lower.

### DESCRIPTION OF THE DRAWINGS

FIG. 1 is a diagram showing a configuration of an AC/DC converter according to the first embodiment of the present disclosure.

FIG. 2 is a diagram showing an example of operation waveforms in an AC/DC converter provided with a power control device according to a comparative example.

FIG. 3 is a diagram showing examples of the waveform of a drain current.

FIG. 4 is a diagram showing a configuration example of the oscillator.

FIG. 5 is a diagram showing an example of the correspondence between a switching frequency and an input voltage.

FIG. 6 is a diagram showing an example of operating waveforms in an AC/DC converter including a power control device according to the first embodiment.

FIG. 7 is a diagram showing a configuration of an AC/DC converter including a power control device according to a second embodiment of the present disclosure.

FIG. 8 is a diagram showing an example of a waveform of a drain voltage during switching.

FIG. 9 is a diagram showing a configuration of an AC/DC converter including a power control device according to a third embodiment of the present disclosure.

FIG. 10 is a diagram showing an example of the waveform of the winding voltage during switching.

FIG. 11 is a diagram showing a configuration of an AC/DC converter including a power control device according to a fourth embodiment of the present disclosure.

FIG. 12 is a diagram showing an example of a configuration of an AC adapter.

### DESCRIPTION OF THE PREFERED EMBODIMENTS

Hereinafter, illustrative embodiments of the present disclosure will be described with reference to the drawings.

### 1. First Embodiment

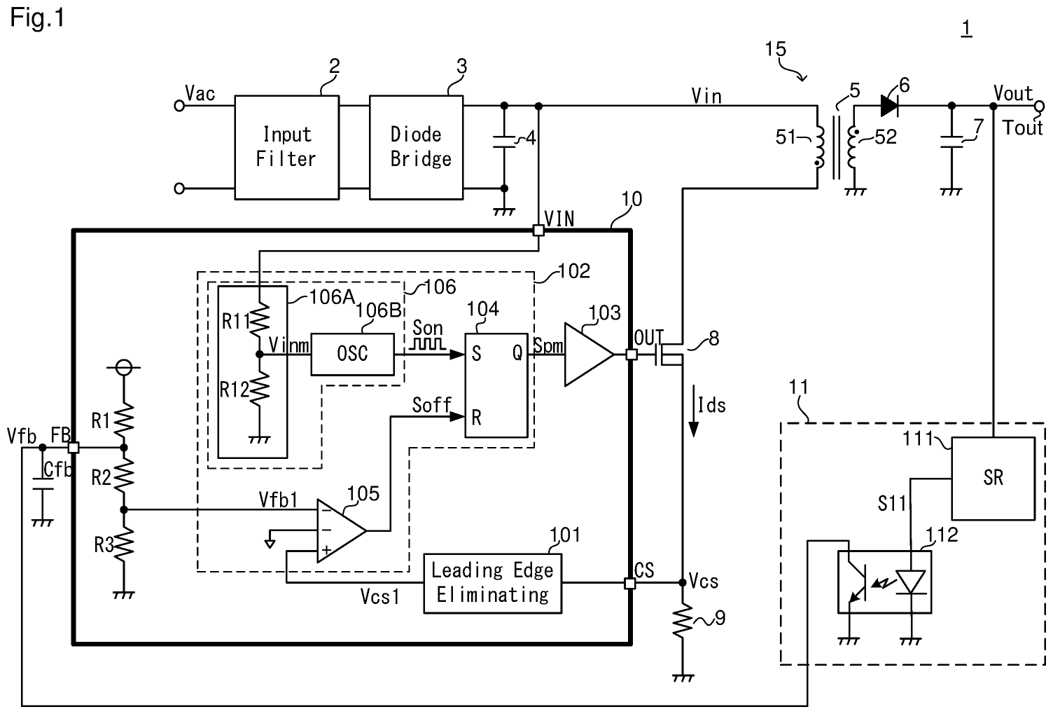

FIG. 1 is a diagram showing the configuration of an AC/DC converter 1 according to a first embodiment of the present disclosure. The AC/DC converter 1 includes an input filter 2, a diode bridge 3, an input capacitor 4, and a DC/DC converter 15.

An alternating-current voltage Vac is fed to the input filter 2. The input filter 2 eliminates noise in the alternating-current voltage Vac. The diode bridge 3 is a rectification circuit that performs full-wave rectification on the alternating-current voltage Vac. The output voltage of the diode bridge 3 is smoothed by the input capacitor 4 to be converted into an input voltage Vin, which is a direct-current voltage.

The insulated DC/DC converter 15 bucks the input voltage Vin to feed an output voltage Vout stabilized at a target value to a load (not illustrated) connected to an output terminal Tout.

The DC/DC converter 15 has a transformer 5, a diode 6, an output capacitor 7, a switching element 8, a sense resistor 9, a power control device 10, and a feedback circuit 11. The DC/DC converter 15 is what is called a flyback converter.

The transformer 5 has a primary winding 51 and a secondary winding 52. The first terminal of the primary winding 51 is connected to an application terminal for the input voltage. The switching element 8 is configured as an N-channel MOSFET (metal-oxide-semiconductor field-effect transistor). The second terminal of the primary winding 51 is connected to the drain of the switching element 8. The source of the switching element 8 is connected to the first terminal of the sense resistor 9. The second terminal of the sense resistor 9 is connected to a ground terminal.

The first terminal of the secondary winding 52 is connected to the ground terminal. The second terminal of the secondary winding 52 is connected to the anode of the diode 6. The cathode of the diode 6 is connected to the first terminal of the output capacitor 7. The second terminal of the output capacitor 7 is connected to the ground terminal. The output terminal Tout is connected to the first terminal of the output capacitor 7.

The power control device 10 is a control IC (semiconductor device) having an OUT terminal (a switching output terminal), a CS terminal (a current sensing terminal), an FB terminal (a feedback terminal), and a VIN terminal (an input voltage terminal) as external terminals for establishing electrical connection with the outside.

The OUT terminal is connected to the gate of the switching element 8. The power control device 10 switches the switching element 8 to buck the input voltage Vin and generate the output voltage Vout. The power control device 10 adjusts the switching duty of the switching element 8 to stabilize the output voltage Vout at the target value and control the drain current Ids flowing through the switching element 8.

Across the sense resistor 9, a sense voltage Vcs proportional to the drain current Ids appears. The sense voltage Vcs is fed to the CS terminal of the power control device 10. The power control device 10 controls the drain current Ids based on the sense voltage Vcs.

The feedback circuit 11 generates a feedback voltage Vfb according to the output voltage Vout and feeds the feedback voltage Vfb to the FB terminal. The feedback circuit 11 has a shunt regulator 111 and a photocoupler 112. The shunt regulator 111 is an error amplifier; it generates a feedback signal S11 of which the level is adjusted such that the error between the output voltage Vout and a predetermined target value is zero and that feeds the feedback signal S11 to a light-emitting diode in the photocoupler 112. A phototransistor in the photocoupler 112 converts a light signal from the light emitting diode into the feedback voltage Vfb according to the feedback signal S11.

The power control device 10 has integrated in it an edge blanking circuit 101, a pulse modulator 102, a driver 103, a pull-up resistor R1, and voltage division resistors R2 and R3.

Immediately after the switching element 8 turns on (switches from off to on), a surge voltage that momentarily rises appears in the sense voltage Vcs. To prevent the surge voltage from turning off (switching from on to off) the switching element 8, the edge blanking circuit 101 masks the sense voltage Vcs in a mask period immediately after the switching element 8 turns on.

The FB terminal is externally connected to a capacitor Cfb and is pulled up by the pull-up resistor R1. The feedback voltage Vfb is divided by the voltage division resistors R2 and R3.

The pulse modulator 102 generates a pulse modulation-signal Spm, comprising pulses, of which the duty ratio is adjusted according to the feedback voltage Vfb. The pulse modulator 102 controls the timing at which to turn off the switching element 8 according to the sense voltage Vcs proportional to the drain current Ids flowing through the switching element 8. That is, the pulse modulator 102 is a peak current mode modulator. The driver 103 switches the switching element 8 according to the pulse signal Spm.

The pulse modulator 102 includes a flip-flop 104, a comparator 105, and a switching frequency controller 106.

The comparator 105 compares a feedback voltage Vfbl resulting from dividing the feedback voltage Vfb and a sense voltage Vcsl fed from the edge blanking circuit 101, and generates an off-signal Soff that is asserted when the sense voltage Vcsl reaches the feedback voltage Vfbl.

The switching frequency controller 106 has an input voltage monitor 106A and an oscillator 106B. The oscillator 106B generates an on-signal Son that is asserted at a predetermined period. The on-signal Son is a pulse signal (clock) with a predetermined frequency. The frequency of the on-signal Son generated by the oscillator 106B is variable and this will be described later.

The set terminal (S) of the flip-flop 104 is fed with the on-signal Son and its reset terminal (R) is fed with the off-signal Soff. The pulse modulation-signal Spm fed from the flip-flop 104 shifts to an on level (high level) corresponding to the on state of the switching element 8 every time the on-signal Son is asserted, and shifts to an off level (low level) corresponding to the off state of the switching element 8 every time the off-signal Soff is asserted. That is, the pulse modulation signal Spm is a signal modulated by PWM (pulse width modulation).

In the power control device 10 according to this embodiment, the switching frequency of the switching element 8 can be variably controlled by the switching frequency controller 106. Here, with the embodiment set aside for a while, a comparative example will be described to clarify problems.

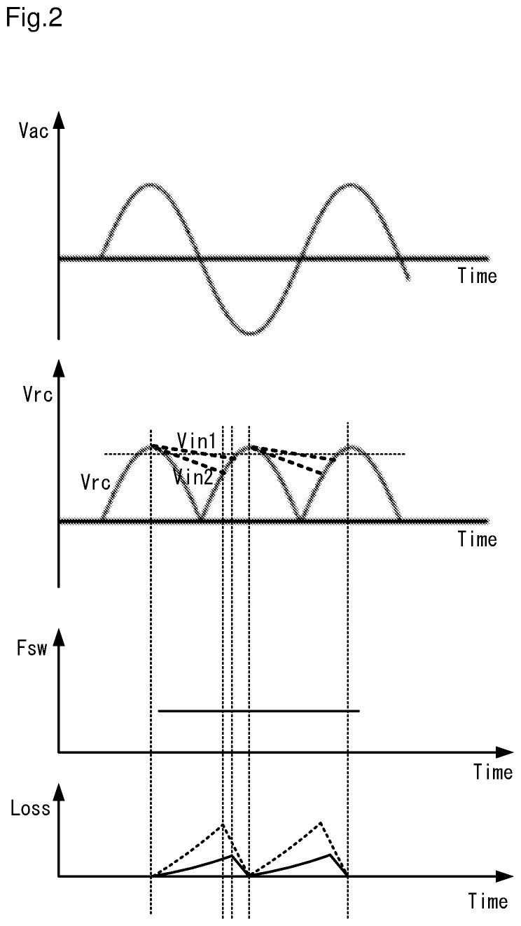

In the power control device according to the comparative example, the switching frequency is fixed. That is, in the configuration shown in FIG. 1, the frequency of the on-signal Son fed to the set terminal of the flip-flop 104 is fixed. FIG. 2 shows an example of operation waveforms in the AC/DC converter provided with the power control device according to the comparative example.

The waveform diagram in FIG. 2 shows, from top down, the alternating-current voltage Vac, an alternating-current voltage Vrc having undergone full-wave rectification, the input voltage Vin, the switching frequency Fsw, and the loss in the switching element 8.

As shown in FIG. 2, when the alternating-current voltage Vrc starts to fall, the input capacitor 4 discharges and so the input voltage Vin starts to fall. When the input voltage Vin reaches the alternating-current voltage Vrc, as the alternating-current voltage Vin rises, the input capacitor 4 is charged and the input voltage Vin rises so as to follow the alternating-current voltage Vrc. The input voltage Vin repeats this behavior. Note that, in FIG. 2, an input voltage Vin2 is observed when the capacitance of the input capacitor 4 is lower than an input voltage Vin1 is observed. Thus, as the capacitance of the input capacitor 4 is lower, the input voltage Vin falls with a steeper gradient.

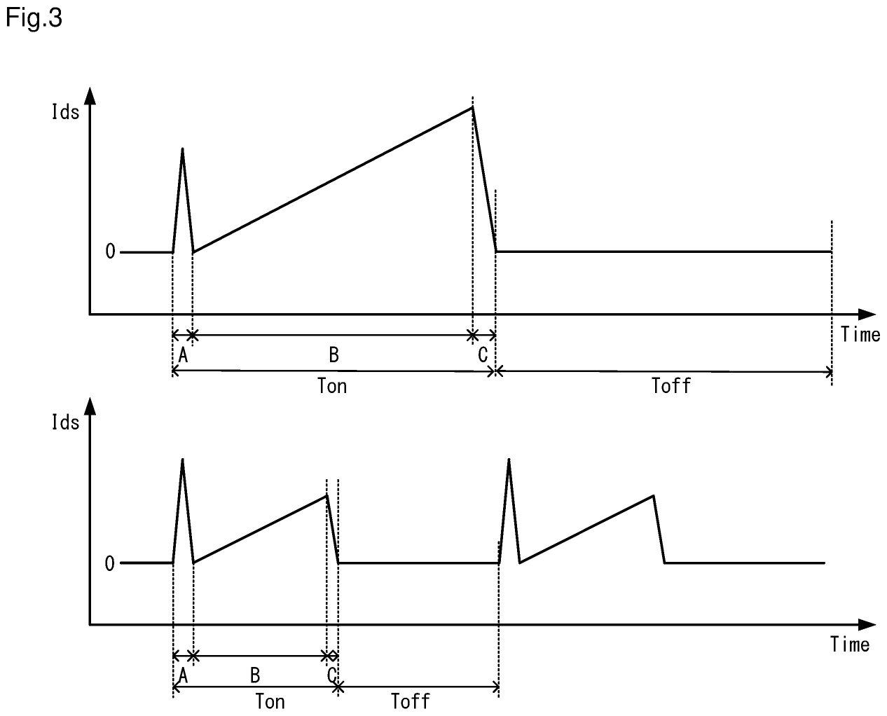

Here, the switching element 8 repeats switching in one cycle of the alternating-current voltage Vac. In the upper part of FIG. 3 is shown an example of the waveform of the drain current Ids in one switching cycle according to the comparative example. One switching cycle is represented by the sum of an on-time Ton and an off-time Toff. The on-time Ton is represented by the sum of a turn-on period A, a conduction period B, and a turn-off period C. In the turn-on period A, the drain current Ids instantaneously rises. After that, in the conduction period B, the drain current Ids gradually rises. Then, in the turn-off period C, the drain current Ids falls to 0. In the off-time Toff, the drain current Ids is 0.

As shown in FIG. 2, in the comparative example, the switching frequency Fsw is fixed. Thus, one switching cycle shown in the upper part of FIG. 3, given by Ton+Toff, is fixed. Here, in a period in which the input voltage Vin falls, PWM control adjusts the duty, given by Ton/(Ton+Toff), so as to increase it. That is, the on-time Ton increases, and so the peak value in the conduction period B of the drain current Ids becomes higher. This results in a higher conduction loss in the switching element 8. In particular, as the capacitance of the input capacitor 4 is lower as the input voltage Vin2 shown in FIG. 2, the input voltage Vin is still lower, resulting in a still higher duty and a still higher conduction loss.

The loss in the switching element 8 includes not only the conduction loss but also a switching loss in in the turn-on period A and the turn-off period C. Even so, as the duty increases, the lengths of the turn-on period A and the turn-off period C remain almost unchanged, and thus there is almost no change in the switching loss.

As described above, as the loss Loss shown in FIG. 2 indicates, the input voltage Vin2 (broken line) observed with a lower capacitance in the input capacitor 4, compared to the input voltage Vin1 (solid line) observed with a higher capacitance in the input capacitor 4, leads to an increased loss in the switching element 8 and increased heat generation. Thus, the comparative example has the drawback of difficulty in reducing the size of the input capacitor 4.

To cope with that, the power control device 10 according to this embodiment has a configuration in which the switching frequency is variably controlled by the switching frequency controller 106. As shown in FIG. 1, the switching frequency controller 106 has an input voltage monitor 106A and an oscillator 106B.

The input voltage monitor 106A has division resistors R11 and R12, and by dividing the input voltage Vin fed to the VIN terminal with the division resistors R11 and R12, monitors the input voltage Vin. An input voltage Vinm resulting from voltage division is fed to the oscillator 106B. The oscillator 106B variably controls the frequency of the on-signal Son according to the input voltage Vinm. Through the adjustment of the frequency of the on-signal Son, the frequency of the pulse modulation-signal Spm is adjusted and the switching frequency of the switching element 8 is adjusted. Depending on the withstand voltage of the element in the oscillator 106B, the input voltage monitor 106A may be omitted.

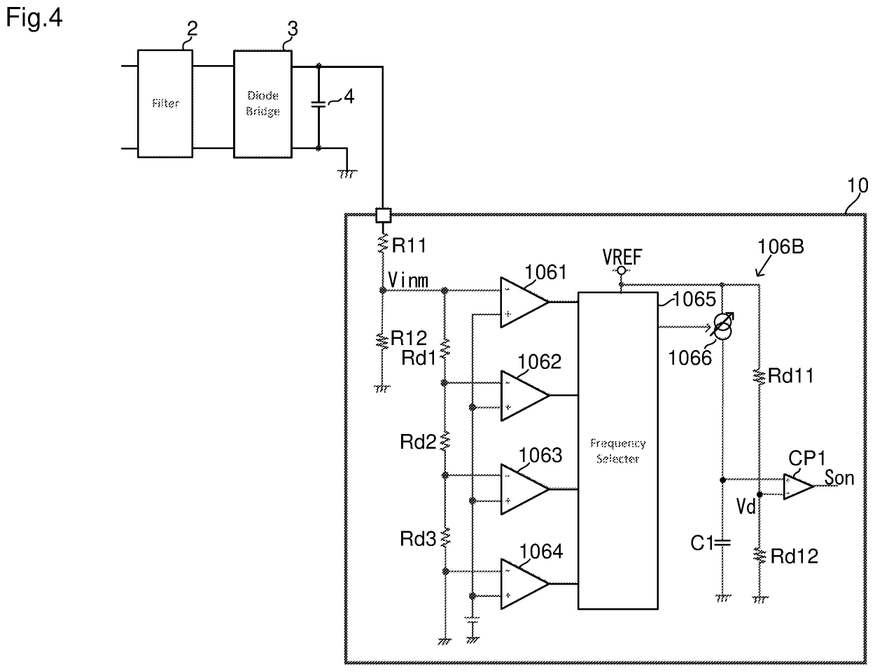

FIG. 4 is a diagram showing a configuration example of the oscillator 106B. The oscillator 106B has division resistors Rd1 to Rd3, comparators 1061 to 1064, a frequency selector 1065, a constant-current source 1066, a capacitor C1, division resistors Rd11 and Rd12, and a comparator CP1. The input voltage Vinm is fed to the first input terminal of the comparator 1061 and a voltage resulting from the input voltage Vinm being divided by the division resistors Rd1 to Rd3 is fed to the first input terminal of each of the comparators 1062 to 1064. The second input terminal of each of the comparators 1062 to 1064 is fed with a reference voltage. The frequency selector 1065 varies the current value of the constant-current source 1066 according to the output of the comparators 1061 to 1064. A node to which the constant-current source 1066 and the capacitor C1 are connected is connected to the first input terminal of the comparator CP1. A voltage Vd resulting from an internal voltage VREF being divided by the division resistors Rd11 and Rd12 is fed to the second input terminal of the comparator CP1. According to the current value of the constant-current source 1066, the speed at which, as the capacitor C1 is charged, the voltage across it rises changes and the frequency of the on-signal Son fed from the comparator CP1 changes. Note that when the voltage of the capacitor C1 exceeds the division voltage Vd, the capacitor C1 is discharged.

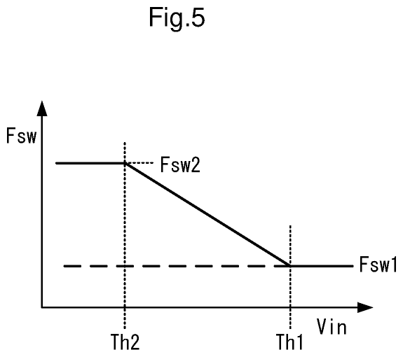

FIG. 5 shows an example of the correspondence between the controlled switching frequency Fsw and the input voltage Vin. As shown in FIG. 5, at or above a first threshold Th1 of the input voltage Vin, the switching frequency Fsw is constant at a lower limit value Fsw1. As the input voltage Vin becomes lower below the first threshold Th1, the switching frequency Fsw becomes higher. Meanwhile, the switching frequency Fsw varies linearly with respect to the input voltage Vin. The variation here need not be linear, and may be curved.

When the input voltage Vin is lower than a second threshold Th2 (<Th1), the switching frequency Fsw is constant at an upper limit value Fsw2. The upper limit value Fsw2 at which the switching frequency Fsw is clamped is determined based on noise standards. The broken line shown in FIG. 5 indicates the correspondence in the comparative example, where the switching frequency Fsw is constant regardless of the input voltage Vin.

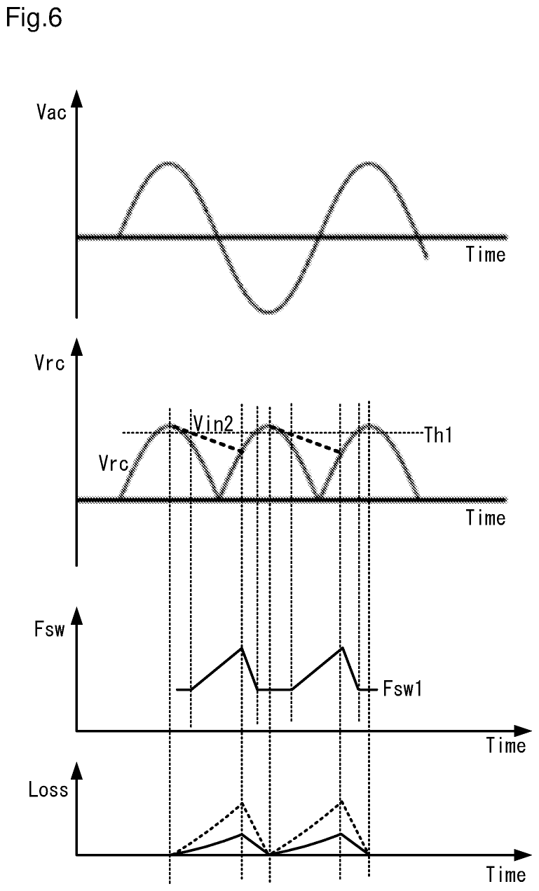

FIG. 6 shows an example of operating waveforms in the AC/DC converter 1 including the power control device 10 according to this embodiment. That is, in FIG. 6, the switching frequency Fsw is variably controlled according to the input voltage Vin. The waveform type shown in FIG. 6 is similar to that in FIG. 2 described above. Note however that the input voltage Vin shown there is the input voltage Vin2 observed with a lower capacitance in the input capacitor 4.

As shown in FIG. 6, when the input voltage Vin falls below the first threshold Th1, as the input voltage Vin falls, the switching frequency Fsw rises. Then, as the input voltage Vin rises so as to follow the alternating-current voltage Vrc, the switching frequency Fsw falls. When the input voltage Vin becomes equal to or higher than the first threshold Th1, the switching frequency Fsw becomes constant at the lower limit value Fsw1.

In the lower part of FIG. 3 is shown an example of the waveform of the drain current Ids observed when switching duty is kept unchanged and the switching frequency is raised compared to the upper part. As shown there, raising the switching frequency shortens the conduction period B and lowers the peak value of the drain current Ids, resulting in a lower condition loss. On the negative side, raising the switching frequency increases the number of times of occurrence of the turn-on period A and the turn-off period C per unit length of time, resulting in an increased switching loss.

When the switching element 8 uses Si (silicon) as a semiconductor material, the turn-on period A and the turn-off period C cannot be shortened, so the effect of an increase in switching loss is greater than that of a decrease in conduction loss and this suppresses the effect of reducing the loss in the switching element 8. However, using GaN (gallium nitride), for example, as the semiconductor material for the switching element 8 makes it possible to minimize the turn-on period A and the turn-off period C, to reduce the effect in increase in switching loss on a decrease in conduction loss, and thus to increase the effect of reducing the loss in the switching element 8. A similar loss reduction effect can be secured by using a wide-bandgap semiconductor such as SiC (silicon carbide) other than GaN as the semiconductor material for the switching element 8. It is particularly preferable to use GaN, which has a larger bandgap.

Even if, as shown in FIG. 6, the capacitance of the input capacitor 4 is low and the drop in the input voltage Vin2 is large, owing to the switching frequency Fsw being raised as the input voltage Vin falls, as shown in loss Loss in FIG. 6, the loss in the switching element 8 can be suppressed in this embodiment (solid line) compared with the comparative example (broken line). This helps reduce the size of the input capacitor 4.

### 2. Second Embodiment

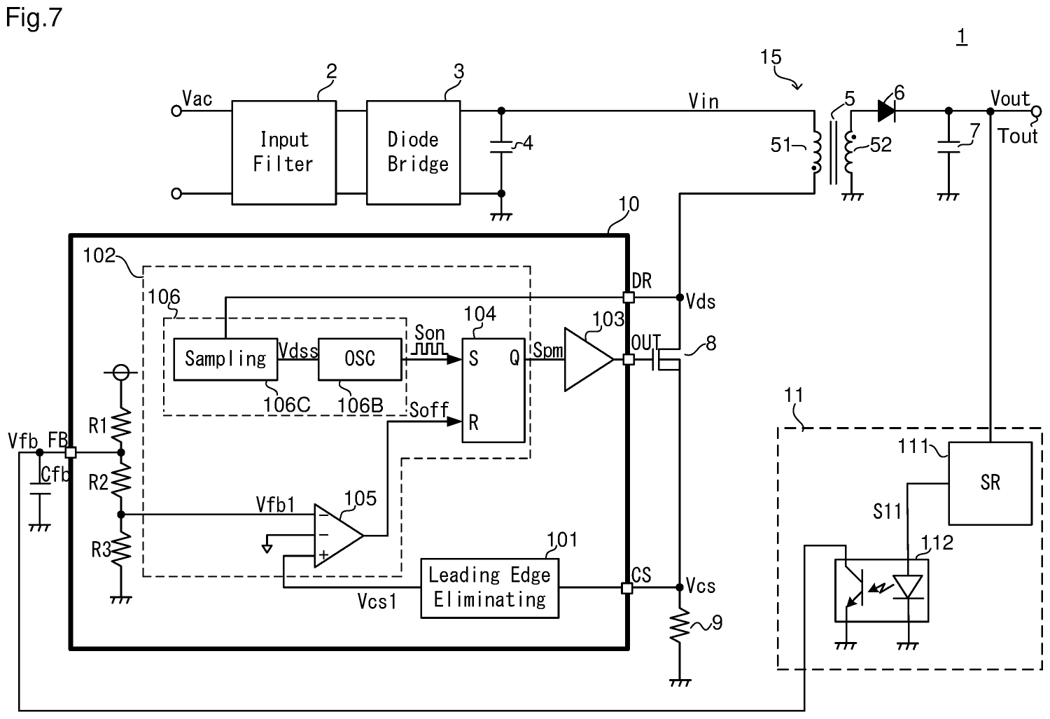

FIG. 7 is a diagram showing a configuration of an AC/DC converter 1 including a power control device 10 according to a second embodiment of the present disclosure. This embodiment differs from the first embodiment in the configuration of a switching frequency controller 106 in the power control device 10. In conformity with this, the power control device 10 is provided with a DR terminal (drain terminal) as an external terminal.

The switching frequency controller 106 according to this embodiment includes a drain voltage sampler 106C and an oscillator 106B. The drain voltage sampler 106C is configured to sample the drain voltage Vds of the switching element 8 that is applied to the DR terminal.

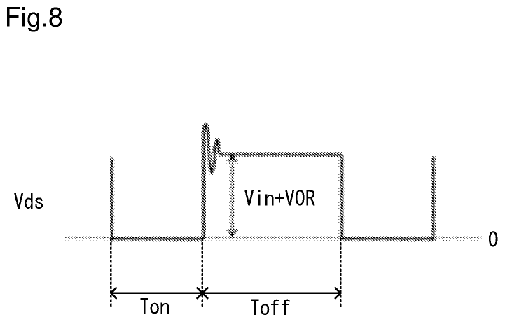

FIG. 8 shows an example of the waveform of the drain voltage Vds during switching. The drain voltage Vds is 0 V during the on-time Ton, and the drain voltage Vds is equal to Vds=Vin+VOR during the off-time Toff. Here, VOR=(Np/Ns)·(Vout+Vf). Np is the number of turns of the primary winding 51, Ns is the number of turns of the secondary winding 52, and Vf is the forward voltage of the diode 6.

Thus, the drain voltage Vds during the off-time Toff is a function of the input voltage Vin, so the drain voltage sampler 106C samples the drain voltage Vds during the off-time Toff. As shown in FIG. 8, a ringing occurs in the drain voltage Vds immediately after a turn-off, so it is preferable to sample later than immediately after a turn-off.

The oscillator 106B variably controls the frequency of the on-signal Son according to the drain voltage Vdss after sampling. Specifically, it operates such that, the lower the drain voltage Vdss, the higher the frequency of the on-signal Son. Thus, the lower the input voltage Vin, the higher the switching frequency of the switching element 8, and this provides similar effects as in the first embodiment.

### 3. Third Embodiment

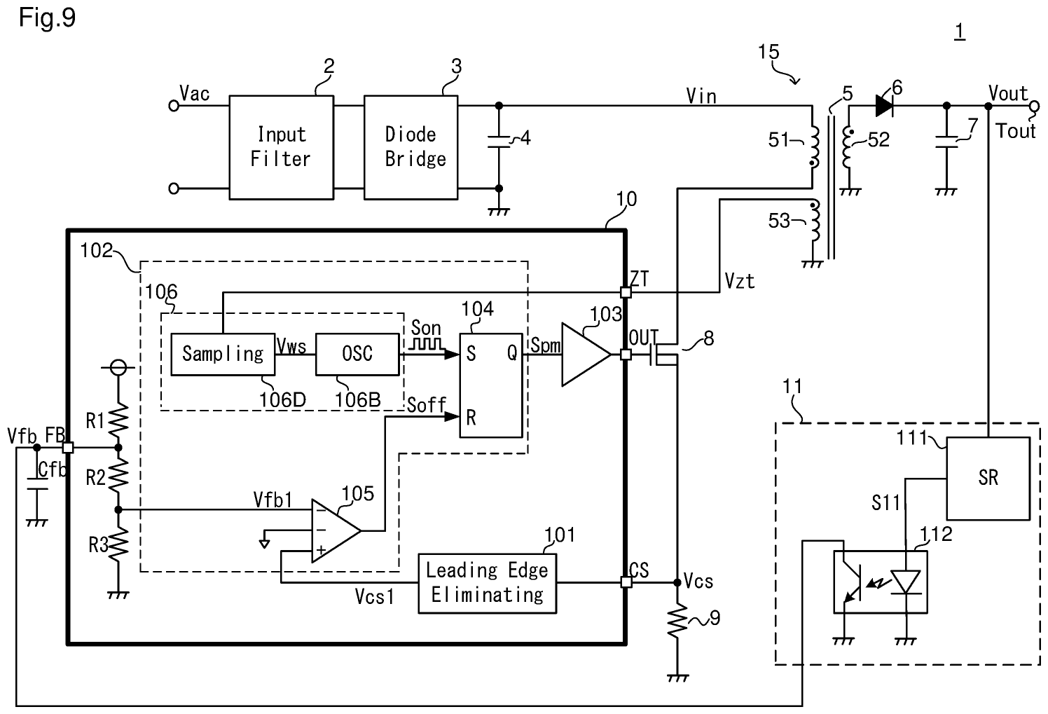

FIG. 9 is a diagram showing a configuration of an AC/DC converter 1 including a power control device 10 according to a third embodiment of the present disclosure. In this embodiment, in the AC/DC converter 1, the transformer 5 has an auxiliary winding 53. This embodiment differs from the first embodiment also in the configuration of the switching frequency controller 106 in the power control device 10. In conformity with this, the power control device 10 is provided with a ZT terminal (winding connection terminal) as an external terminal.

The switching frequency controller 106 according to this embodiment includes a winding voltage sampler 106D and an oscillator 106B. The winding voltage sampler 106D is configured to sample the winding voltage Vzt across the auxiliary winding 53 that is applied to the ZT terminal.

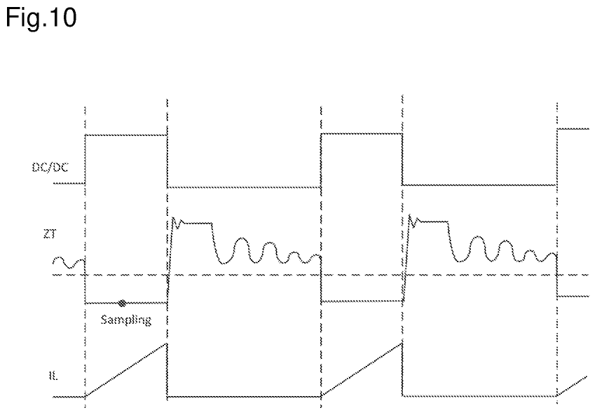

FIG. 10 shows an example of, from top down, the on/off state of the switching element 8 and the waveforms of the winding voltage Vzt and a current IL through a primary winding 51 during switching. As shown in FIG. 10, the winding voltage sampler 106D samples the winding voltage Vzt (negative voltage) when the switching element 8 is on.

The oscillator 106B variably controls the frequency of the on-signal Son according to the winding voltage Vws (positive voltage) after sampling. Specifically, it operates such that, the lower the winding voltage Vws, the higher the frequency of the on-signal Son. Thus, the lower the input voltage Vin, the higher the switching frequency of the switching element 8, and this provides similar effects as in the first embodiment.

### 4. Fourth Embodiment

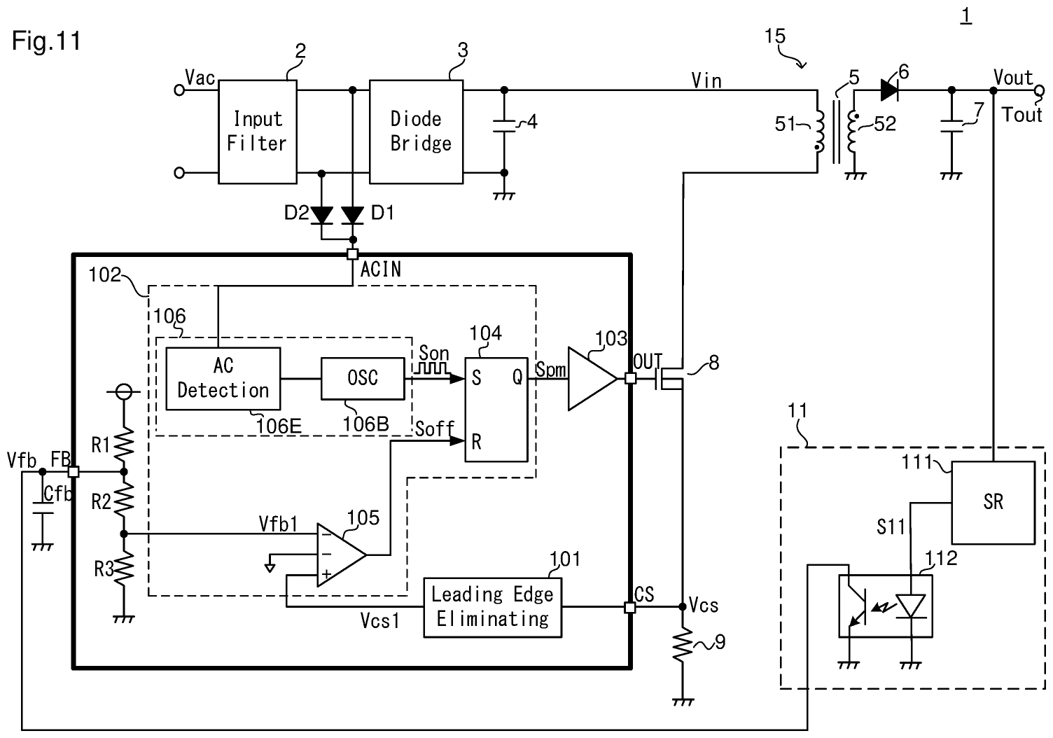

FIG. 11 is a diagram showing a configuration of an AC/DC converter 1 including a power control device 10 according to a fourth embodiment of the present disclosure. This embodiment differs from the first embodiment in the configuration of the switching frequency controller 106 in the power control device 10. In conformity with this, the power control device 10 is provided with an ACIN terminal (AC input terminal) as an external terminal.

The switching frequency controller 106 according to this embodiment includes an Alternating-current voltage sensor 106E and an oscillator 106B. A diode D1 is connected between the ACIN terminal and a positive output line of the input filter 2 and a diode D2 is connected between the ACIN terminal and a negative output line of the input filter 2. The Alternating-current voltage sensor 106E is configured to sense the voltage level of the Alternating-current voltage Vac based on the voltage that is applied to the ACIN terminal. For example, the Alternating-current voltage Vac has different voltage levels such as 100 V and 240 V from country to country. The oscillator 106B variably controls the frequency of the on-signal Son according to the sensing result from the Alternating-current voltage sensor 106E. Specifically, it operates such that, the lower the sensed voltage level, the higher the frequency of the on-signal Son. Thus, the lower the voltage level of the Alternating-current voltage Vac, the lower the peak value of the Alternating-current voltage Vac and the lower the input voltage Vin. Thus, the lower the input voltage Vin, the higher the switching frequency of the switching element 8, and this helps suppress the loss in the switching element 8 regardless of the voltage level of the Alternating-current voltage Vac.

### 5. Ac Adapter

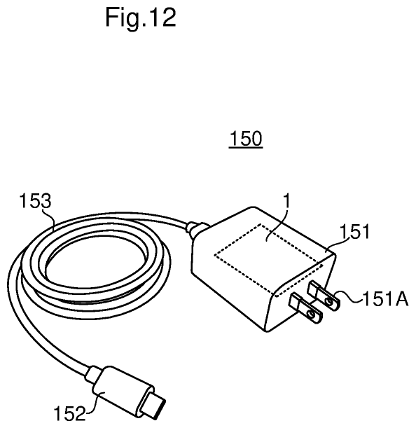

FIG. 12 is a diagram showing an example of a configuration of an AC adapter 150 as an example of application of an AC/DC converter 1 according to an embodiment of the present disclosure.

The AC adapter 150 shown in FIG. 12 includes an adapter body 151, a DC plug 152, and a cable 153. The adapter body 151 is provided with outlet plugs 151A. The outlet plugs 151A are connectable to an outlet. The AC/DC converter 1 is built in the adapter body 151.

The adapter body 151 and the DC plug 152 are connected together by a cable 153. The Alternating-current voltage Vac fed to the insertion plug 151A is converted by the AC/DC converter 1 into an output voltage Vout, which is a direct-current voltage. The output voltage Vout is fed out from the DC plug 152 via the cable 153. Devices such as smartphones and tablets are connectable to the DC plug 152.

As described above, the AC/DC converter 1 allows reduction of the size of the input capacitor 4 and thus helps reduce the adapter body 151 in size and weight.

### 6. Other Modifications

The various technical features disclosed herein can be modified from the embodiments described above in various ways without departure from the spirit of the technical ingenuity. It should be understood that the above-described embodiments are in every aspect illustrative and not restrictive. The technical scope of the present disclosure is defined not by the description of the embodiments given above but by the appended claims, and encompasses any modifications made without departure from the scope and sense equivalent to those claims.

### 7. Notes

As described above, according to one aspect of the present disclosure, a power control device (10) is configured to control a DC/DC converter (15) in an AC/DC converter (1), and includes a rectification circuit (3) configured to be fed with an alternating-current voltage (Vac), an input capacitor (4) configured to smooth the voltage rectified by the rectification circuit, and the DC/DC converter configured to perform DC/DC conversion on the input voltage (Vin) appearing across the input capacitor. The DC/DC converter includes a switching element (8), and the power control device includes a switching frequency controller (106) configured to increase the switching frequency (Fsw) at which the switching element is switched as the input voltage is lower. (A first configuration.)

In the first configuration described above, the switching element may use a wide-bandgap semiconductor as a semiconductor material. (A second configuration.)

In the second configuration described above, GaN may be used as the semiconductor material. (A third configuration.)

In any one of the first to third configurations described above, the switching frequency controller (106) may be configured to output an on-signal (Son) that is a pulse signal and that determines the timing of the turning-on of the switching element. The switching frequency controller may be configured to control the switching frequency by controlling the frequency of the on-signal. (A fourth configuration.)

In the fourth configuration described above, the switching frequency controller (106) may include an input voltage monitor (106A) configured to monitor the input voltage (Vin), and an oscillator (106B) configured to variably control the frequency of the on-signal according to the result of monitoring by the input voltage monitor. (A fifth configuration.)

In the fifth configuration described above, the input voltage monitor may include voltage division resistors (R11, R12) configured to divide the input voltage. (A sixth configuration.)

In the fourth configuration described above, the switching frequency controller (106) may include a drain voltage sampler (106C) configured to sample the drain voltage (Vds) of the switching element, and an oscillator (106B) configured to variably control the frequency of the on-signal according to the result of sampling by the input voltage sampler. (A seventh configuration.)

In the fourth configuration described above, the switching frequency controller (106) may include a winding voltage sampler (106D) configured to sample the voltage (Vzt) across the auxiliary winding (53) of a transformer (5) in the AC/DC converter (1), and an oscillator (106B) configured to variably control the frequency of the on-signal according to the result of sampling by the winding voltage sampler. (An eighth configuration.)

In the fourth configuration described above, the switching frequency controller (106) may include an alternating-current voltage sensor (106E) configured to sense the voltage level of the alternating-current voltage (Vac) and an oscillator (106B) configured to variably control the frequency of the on-signal according to the result of sensing by the Alternating-current voltage sensor. (A ninth configuration.)

In any one of the first to ninth configuration described above, the switching frequency controller (106) may keep the switching frequency constant at a lower limit value (Fsw1) when the input voltage (Vin) is equal to or higher than a first threshold value (Th1) and may vary the switching frequency when the input voltage is lower than the first threshold. (A tenth configuration.)

In any one of the first to tenth configuration described above, the switching frequency controller (106) may vary the switching frequency when the input voltage (Vin) is equal to or higher than a second threshold value (Th2) and may clamp the switching frequency at an upper limit value (Fsw2) when the input voltage is lower than the second threshold. (An eleventh configuration.)

In any one of the first to eleventh configuration described above, the switching frequency controller (106) may vary the switching frequency (Fsw) linearly with respect to the input voltage (Vin). (A twelfth configuration.)

According to another aspect of the present disclosure, an AC/DC converter (1) includes the power control device (10) according to any one of the first to twelfth configurations, a transformer (5) including a primary winding (51) having the first terminal configured to be connected to an application terminal for the input voltage (Vin) and a secondary winding (52) having the first terminal configured to be connected to a ground terminal, the switching element (8) configured to be connected to the second terminal of the primary winding, a diode (6) having the anode configured to be connected to the second terminal of the secondary winding, and an output capacitor (7) configured to be connected to the cathode of the diode. (A thirteenth configuration.)

According to yet another aspect of the present disclosure, an AC adapter (150) includes an adapter body (151) which incorporates the AC/DC converter (1) including the power control device (10) according to any one of the first to twelfth configurations. (A fourteenth configuration.)

What is claimed is:

1. A power control device configured to control a DC/DC converter in an AC/DC converter comprising:
a rectification circuit configured to be fed with an alternating-current voltage;
an input capacitor configured to smooth a voltage rectified by the rectification circuit; and
the DC/DC converter configured to perform DC/DC conversion on an input voltage appearing across the input capacitor,
wherein
the DC/DC converter includes a switching element, and
the power control device includes a switching frequency controller configured to increase a switching frequency at which the switching element is switched as the input voltage is lower.

2. The power control device according to claim 1, wherein
the switching element uses a wide-bandgap semiconductor as a semiconductor material.

3. The power control device according to claim 2, wherein
GaN is used as the semiconductor material.

4. The power control device according to claim 1, wherein
the switching frequency controller is configured to output an on-signal that is a pulse signal and that determines timing of turning-on of the switching element, and
the switching frequency controller is configured to control the switching frequency by controlling a frequency of the on-signal.

5. The power control device according to claim 4, wherein
the switching frequency controller includes:
an input voltage monitor configured to monitor the input voltage; and
an oscillator configured to variably control the frequency of the on-signal according to a result of monitoring by the input voltage monitor.

6. The power control device according to claim 5, wherein
the input voltage monitor includes voltage division resistors configured to divide the input voltage.

7. The power control device according to claim 4, wherein
the switching frequency controller includes:
a drain voltage sampler configured to sample a drain voltage of the switching element; and
an oscillator configured to variably control the frequency of the on-signal according to a result of sampling by the input voltage sampler.

8. The power control device according to claim 4, wherein
the switching frequency controller includes:
a winding voltage sampler configured to sample a voltage across an auxiliary winding of a transformer in the AC/DC converter; and
an oscillator configured to variably control the frequency of the on-signal according to a result of sampling by the winding voltage sampler.

9. The power control device according to claim 4, wherein
the switching frequency controller includes:
an Alternating-current voltage sensor configured to sense a voltage level of the alternating-current voltage; and
an oscillator configured to variably control the frequency of the on-signal according to a result of sensing by the Alternating-current voltage sensor.

10. The power control device according to claim 1, wherein
the switching frequency controller
keeps the switching frequency constant at a lower limit value when the input voltage is equal to or higher than a first threshold value and
varies the switching frequency when the input voltage is lower than the first threshold.

11. The power control device according to claim 1, wherein
the switching frequency controller
varies the switching frequency when the input voltage is equal to or higher than a second threshold value and
clamps the switching frequency at an upper limit value when the input voltage is lower than the second threshold.

12. The power control device according to claim 1, wherein
the switching frequency controller varies the switching frequency linearly with respect to the input voltage.

13. An AC/DC converter comprising:
the power control device according to claim 1;
a transformer including:
a primary winding having a first terminal configured to be connected to an application terminal for the input voltage; and
a secondary winding having a first terminal configured to be connected to a ground terminal;
the switching element configured to be connected to a second terminal of the primary winding;
a diode having an anode configured to be connected to a second terminal of the secondary winding; and
an output capacitor configured to be connected to a cathode of the diode.

14. An AC adapter comprising:
an adapter body which incorporates the AC/DC converter including the power control device according to claim 1.
